(19) United States
(12) Patent Application Publication
(10) Pub. No.: US 2002/0051559 A1
(43) Pub. Date: May 2, 2002

(54) Application of bit-plane decomposition steganography to progressively compressed data

(76) Inventors: Hideki Noda, Munakata-shi (JP); Eiji Kawaguchi, Munakata (JP); Richard Eason, Orono, ME (US); Kunihiro Tsuda, Kitakyushu (JP)

Correspondence Address: Lawson, Philpot & Persson, P.C., Suite 110, 67 Water Street, Laconia, NH, 03246, US

(21) Appl. No.: 09/949,522

(22) Filed: Sep. 7, 2001

(30) Foreign Application Priority Data
Sep. 7, 2000 (JP) 2000-270978

(51) Int. Cl. G06K 9/00; G06K 9/46

(52) U.S. Cl. 382/100; 382/240

(57) ABSTRACT

Media data such as still image data is subjected to a wavelet transform, and then the wavelet coefficients are quantized. Bit-planes are prepared for the quantized wavelet coefficients. Confidential information is embedded into the bit-planes by using bit-plane decomposition steganography. The modified quantized wavelet coefficients are prepared based on the bit-planes into which the confidential information is embedded. Entropy encoding is performed on the modified quantized wavelet coefficients. As a result, the information is hidden in the media data subjected to progressive compression. On the other hand, entropy decoding is performed on the compressed data, into which the confidential information is embedded, to obtain quantized wavelet coefficients. A bit-plane structure is obtained from the quantized wavelet coefficients, and the hidden information is extracted from the bit-plane structure. In data communication using the compressed data, a third person is not aware of the presence of the hidden information, so that the security thereof can be enhanced. The bit-plane decomposition steganography becomes applicable to compressed data and is improved in the convenience and safety of its utilization.

This Application claims the benefit, under 35 USC 119, based upon a prior filing in a state that is a member of the Paris Convention, of Japanese Patent Application Serial Number 2000-270978, filed on Sep. 7, 2000.

### FIELD OF THE INVENTION

The present invention relates to a technique for hiding information using bit-plane decomposition, and more particularly to a technique of embedding confidential information into irreversibly compressed data using bit-plane decomposition steganography such as bit-plane complexity segmentation (BPCS) steganography and pixel-difference complexity segmentation (PDCS), and extracting it.

### BACKGROUND OF THE INVENTION

Bit-plane decomposition steganography is a steganography technique that can hide a large amount of information without degrading the quality of media data and without increasing the size of a data file. The term “media data” as used herein means digital data including acoustic data, still image data and video data.

In steganography based on bit-plane decomposition including BPCS-steganography, it has hitherto been impossible to hide information into irreversibly compressed media data (acoustic data, image data and video data). This is because the hidden information is destroyed by irreversible compression, resulting in a failure to restore it.

In hiding information, various media data, sometimes referred to as dummy data, can act as a container for hiding the confidential information, which itself is digital data that can be text, sound, voice, images or other types. Steganography based on bit-plane decomposition is suitable for communication of confidential data through the Internet as an application field, as described later. In this case, various media data are generally transmitted and received as compressed data.

However, steganography based on bit-plane decomposition has the problem that its utilization to data communication through the Internet is substantially limited. For example, when hidden data is embedded by steganography based on bit-plane decomposition into a still image used as dummy data, communication must be performed by uncompressed or reversibly compressed data, because it is impossible to restore the hidden data from irreversibly compressed dummy data. As a result, the data must be transmitted and received by bit map (BMP) format, or other losslessly compressed file, in which the file size is extremely large.

This is seen as unnatural to external attackers, which allows them to suspect the presence of confidential information, thereby losing the merit of steganography based on bit-plane decomposition, which is most effective when the presence of hidden data is not noticed.

Steganography can also be used in other applications where the presence of the embedded data may be known by outsiders, but the goal is to keep certain information together with the media. In this case, such information can be embedded in the media and later retrieved by client applications. A great number of such potential applications use irreversibly compressed media, which previously could not make use of the high embedding capacity offered by the bit-plane decomposition methods.

### SUMMARY OF THE INVENTION

The present invention is applicable to all information hiding methods using bit-plane decomposition. In using compressed data as the dummy data, it is required that the compressed data itself has a bit-plane decomposition structure. Data compression methods having such a structure include EZW, SPIHT and JPEG2000 (Part 1 of JPEG2000) methods for still images and the 3D-SPIHT and Motion-JPEG2000 (Part 3 of JPEG2000 which is under preparation) methods for video data. Furthermore, for acoustic data, there is the method described in “High Quality Audio Compression Using an Adaptive Wavelet Packet Decomposition and Psychoacoustic Modeling”, IEEE Transactions on Signal Processing, Vol. 146, April 1998.

In all of these methods, the original signal (original data) is subjected to a wavelet transform, and the resultant wavelet coefficients are efficiently encoded to perform data compression. In that case, the wavelet coefficient is expressed in such a form that its approximation accuracy is sequentially increased, and can be coordinated with the bit-plane decomposition. Such a compression method is called progressive compression.

The present inventors have found that steganography based on bit-plane decomposition is applicable to irreversibly compressed data by such a progressive compression technique, thus completing the present invention.

According to the present invention, there is provided a method for hiding information in media data subjected to progressive compression including the steps of obtaining a bit-plane structure with respect to the media data when compressing media data, and embedding confidential information into the bit-plane structure by using bit-plane decomposition steganography.

Another embodiment of the present invention provides a method for hiding information in media data subjected to progressive compression including the steps of subjecting media data to a wavelet transform, preparing quantized wavelet coefficients, preparing bit-planes for quantized wavelet coefficients, embedding confidential information into the bit-planes by using bit-plane decomposition steganography, preparing modified quantized wavelet coefficients based on these bit-planes, and performing entropy encoding of the modified quantized wavelet coefficients. The above-mentioned media data includes any one of acoustic data, still image data and video data.

Still another embodiment of the present invention provides a device for hiding information in media data subjected to progressive compression including a means for obtaining a bit-plane structure with respect to the media data when compressing media data, and a means for embedding confidential information into the bit-plane structure by using bit-plane decomposition steganography.

A further embodiment of the present invention provides a device for hiding information in media data subjected to progressive compression, including a means for subjecting media data to a wavelet transform, a means for preparing quantized wavelet coefficients, a means for preparing bit-planes for quantized wavelet coefficients, a means for embedding confidential information into the bit-planes by using bit-plane decomposition steganography, a means for preparing modified quantized wavelet coefficients based on these bit-planes, and a means for performing entropy encoding of the modified quantized wavelet coefficients.

A still further embodiment of the present invention provides an information recording medium housing media data which is subjected to progressive compression and into which confidential information is embedded by bit-plane decomposition steganography.

Still another embodiment of the present invention provides a data communication method using media data into which confidential information is embedded by the methods described above and communicated via a communication system.

Yet still another embodiment of the present invention provides a method for extracting hidden information from media data which is subjected to progressive compression and into which the confidential information is embedded by bit-plane decomposition steganography, which comprises the steps of obtaining a bit-plane structure with respect to the above-mentioned media data, and extracting the above-mentioned hidden information from the bit-plane structure.

A still further embodiment of the present invention provides a method for extracting hidden information including the steps of subjecting media data, which is subjected to progressive compression and into which the confidential information is embedded by bit-plane decomposition steganography, to entropy decoding to obtain quantized wavelet coefficients, obtaining a bit-plane structure from the quantized wavelet coefficients, and extracting the hidden information from the bit-plane structure.

A still further embodiment of the present invention provides a device for extracting hidden information including a means for subjecting media data, which is subjected to progressive compression and into which the confidential information is embedded by bit-plane decomposition steganography, to entropy decoding to obtain quantized wavelet coefficients, a means for obtaining a bit-plane structure from the quantized wavelet coefficients, and a means for extracting the hidden information from the bit-plane structure.

Therefore, it is an aspect of the present invention to make it possible to apply steganography using bit-plane decomposition including BPCS-steganography to irreversibly compressed media data.

Another aspect of the present invention is to greatly improve the convenience and safety of the utilization of steganography based on bit-plane decomposition.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a block diagram showing a functional constitution of an information hiding system embodying the present invention.

FIG. 2 is a block diagram showing a functional constitution of an information extracting system embodying the present invention.

FIG. 3 is a diagram showing a hardware constitution of a system embodying the present invention.

FIG. 4 is a flow chart showing an embedding procedure embodying the present invention.

FIG. 5 is a flow chart showing another embedding procedure embodying the present invention.

FIG. 6 is a flow chart showing an extracting procedure embodying the present invention.

FIG. 7 is a diagram illustrating the conjugation operation embodying the present invention.

FIG. 8 is a diagram illustrating an example of a wavelet transform embodying the present invention.

FIG. 9 is a diagram illustrating another example of a wavelet transform embodying the present invention.

### DETAILED DESCRIPTION OF THE INVENTION

As noted above, the method of the present invention begins with the media data being transformed. For example, the media data is subjected to a wavelet transform. Then, the bit-plane structure is obtained with respect to the quantized transform coefficients. At this time, the confidential information is embedded into the bit-plane structure by using the bit-plane decomposition steganography. As a result, the information is hidden in the media data subjected to the progressive compression. The confidential information may include personal attribute information. Methods for compressing the media data include the EZW method, the SPIHT method and JPEG2000 using wavelet transform.

In some embodiments, the media data is subjected to the wavelet transform and the obtained wavelet coefficients are quantized. A set of bit-planes is prepared for the quantized wavelet coefficients. The confidential information is embedded into the bit-planes by using bit-plane decomposition steganography. Then modified quantized wavelet coefficients are prepared based on these bit-planes. Entropy encoding is performed on the modified quantized wavelet coefficients. As a result, the information is hidden in the media data subjected to the progressive compression.

Embedding of the confidential information will be described using a still image as an example. However, it is recognized that the method is also applicable to other types of dummy data.

When an original image (digital image) is subjected to the wavelet transform, a wavelet-transformed image having the same size as the original image is obtained. The pixel values of the wavelet-transformed image are the wavelet coefficients. In the progressive compression, each wavelet coefficient W is expressed as:

W=T(a₀+a₁2⁻¹+a₂2⁻²+··19 ), aᵢε{0,1}

wherein T is a constant satisfying (½)Wₘₐₓ≦T<Wₘₐₓ, and Wₘₐₓ is a maximum value of the wavelet coefficients of the wavelet-transformed image.

The wavelet coefficient W is represented by the product of a binary decimal (a₀·.a₁ₐ₂···)₂ and T, and a term of the binary expression is present. This shows that the bit-plane structure can also be considered for the wavelet-transformed image.

In the progressive compression, encoding is conducted in order from wavelet coefficients having larger absolute values, and concurrently conducted in order from higher binary expressions (higher bit-planes). That is to say, encoding is conducted in order from more important information, so that decoding can be performed in order from more important information. Accordingly, even if decoding is discontinued on the way, a near optimal result of decoding is achieved under the information amount (decoded amount) obtained until that stage. Thus, the progressive compression is particularly characterized by suitability for Internet communication. The significance of the present invention is great in which the media data subjected to progressive compression can be utilized as dummy data for hiding information.

In all embodiments, the above-mentioned media data may include any one of acoustic data, still image data and video data. With respect to video data that is large in file size, data communication with irreversible compression is carried out. For embedding confidential information therein, it is possible to use a bit-plane decomposition steganography method.

In some embodiments, the media data is subjected to the wavelet transform and the bit-plane structure is obtained based on the wavelet coefficients. The confidential information is embedded into the bit-plane structure by using bit-plane decomposition steganography and entropy encoding is performed for the bit-planes into which the confidential information is embedded. As a result, the information can be hidden in the media data subjected to the progressive compression.

In other embodiments, the media data is subjected to the wavelet transform and the obtained wavelet coefficients are quantized. A set of bit-planes is prepared for the quantized wavelet coefficients and the confidential information is embedded into these bit-planes by using bit-plane decomposition steganography. Modified quantized wavelet coefficients are then prepared based on these bit-planes and entropy encoding is performed of the modified quantized wavelet coefficients. As a result, the information can be hidden in the media data subjected to the progressive compression.

In some embodiments, the information recording medium houses the media data which is subjected to the progressive compression and into which confidential information is embedded by bit-plane decomposition steganography. Examples of the information recording media include IC cards, CD-ROMs and other media. It is also possible to conduct personal authentication by using the hidden information. In such cases, even if a third person can read out information data from the information recording medium, he does not become aware of the presence of the inherent data (confidential information) itself, because the inherent data embedded by steganography is hidden by information data (dummy data). Accordingly, the security of the information-recording medium can be enhanced as the information data is only required to have such a capacity that the inherent data can be embedded by steganography.

In some embodiments, the information-recording medium obtains the bit-plane structure after the wavelet transform, and the confidential information is embedded therein using steganography based on the bit-plane decomposition method.

In some embodiments, data communication is performed using media data that is subjected to progressive compression and into which confidential information is embedded by bit-plane decomposition steganography. This method provides a merit of enhancing the data communication efficiency by compressed data and a merit of allowing a third person not to become aware of the presence of the hidden information in data communication.

In still other embodiments, the above-mentioned media data is communicated through the Internet or other communication system. A third person is not aware of the presence of the hidden information and, even when the communication is interrupted, it may be restored. This media data may be acoustic data, still image data or video data, which further enhances convenience of data communication. In these embodiments, the hidden information is extracted from the media data, which is subjected to progressive compression, and into which the confidential information is embedded by bit-plane decomposition steganography. For this purpose, first, the bit-plane structure is obtained with respect to the above-mentioned media data. Then, the above-mentioned hidden information is extracted from the bit-plane structure. The media data, which is subjected to progressive compression and into which the confidential information is embedded by bit-plane decomposition steganography, may also be subjected to entropy decoding to obtain quantized wavelet coefficients. The bit-plane structure is obtained from the quantized wavelet coefficients and the hidden information is extracted from the bit-plane structure. As a result, the hidden information can be restored and the validity of media data can be confirmed by restoring hidden personal attribute information.

In some embodiments, the above-mentioned media data, which is subjected to progressive compression and into which the confidential information is embedded by bit-plane decomposition steganography, is subjected to entropy decoding, thereby obtaining quantized wavelet coefficients. The bit-plane structure is obtained from the quantized wavelet coefficients, and the hidden information is extracted from the bit-plane structure. This device is also useful in data communication such as the Internet.

An embodiment of a system for hiding information in the media data subjected to progressive compression, by bit-plane decomposition steganography according to the present invention will be described below.

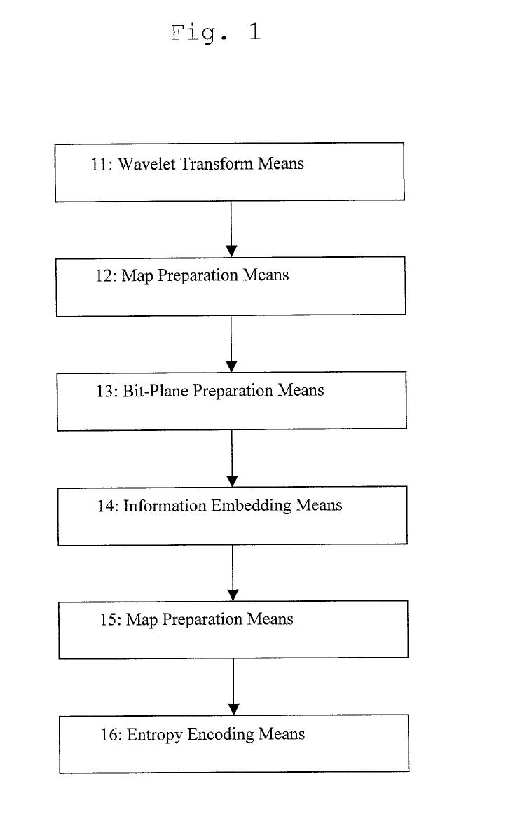

Referring first to FIG. 1, a block diagram is used to describe an information hiding system embodying the present invention, which is applied to the EZW method as a compression method. The information hiding system includes a wavelet transform means 11, a map preparation means 12, a bit-plane preparation means 13, an information embedding means 14, a map preparation means 15 and an entropy encoding means 16.

In the wavelet transform means 11, original image data (dummy data) is subjected to a wavelet transform to obtain a wavelet-transformed image.

In the map preparation means 12, the wavelet coefficients of the above-mentioned wavelet-transformed image are represented as quantized ones by two maps, which are called a significance map and a refinement map, respectively.

In the bit-plane preparation means 13, the bit-plane structure is obtained from the quantized wavelet coefficients represented by the significance map and the refinement map.

In the information embedding means 14, personal attribute information is embedded in this bit-plane structure. Using steganography based on a bit-plane decomposition method (for example, BPCS-steganography), authentication information such as fingerprint information is embedded. In this case, personal authentication information can also be embedded using a customizing key.

In the map preparation means 15, the significance map and the refinement map, which represent modified quantized wavelet coefficients, are prepared from the embedded bit-plane structure.

In the entropy encoding means 16, the significance map and the refinement map are subjected to entropy encoding, thereby preparing a compressed image file having hidden information embedded therein.

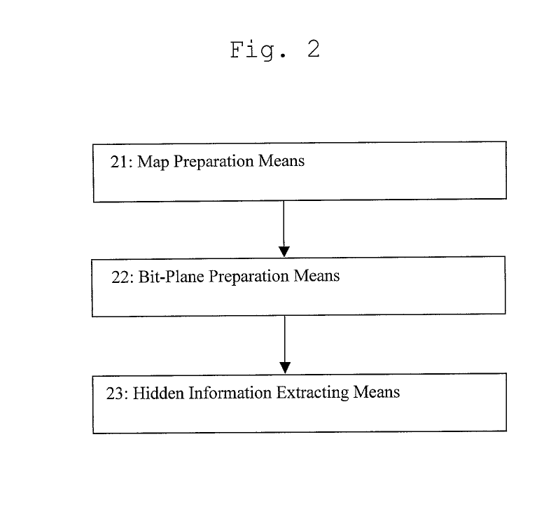

Referring now to FIG. 2, a system (device) for extracting the hidden information from the compressed image file having the hidden information, such as personal authentication information, embedded therein includes a map preparation means 21, a bit-plane preparation means 22 and a hidden information extracting means 23.

In the map preparation means 21, the compressed image file is subjected to entropy decoding to obtain a significance map and a refinement map.

In the bit-plane preparation means 22, bit-planes are prepared from the significance map and the refinement map.

In the hidden information extracting means 23, the hidden information is taken out of the bit-planes. Information extraction is carried out in reverse of the embedding by steganography based on the bit-plane decomposition method.

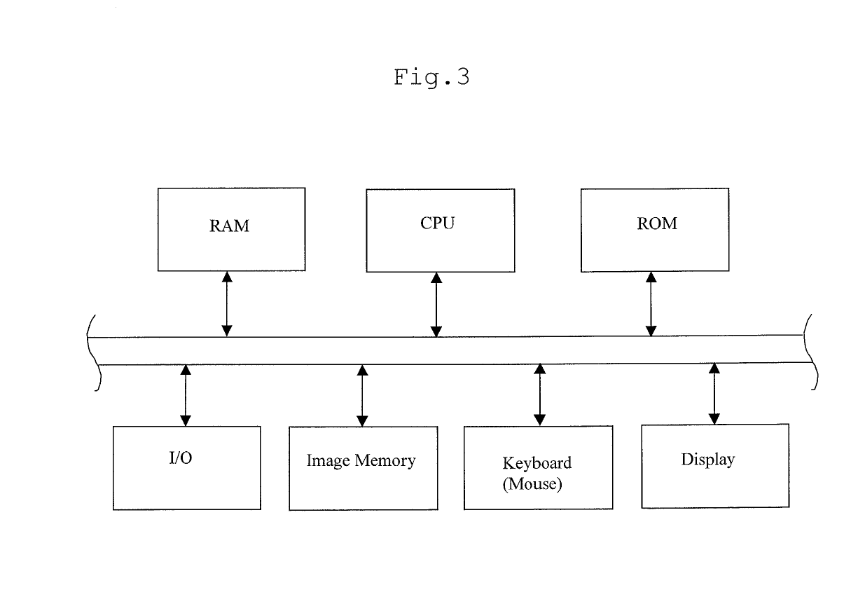

As shown in FIG. 3, the hiding system and extracting system may be made up of computer systems. That is to say, these systems may include CPUs for conducting calculation processing, data memories for storing data, program memories for storing programs, buffer memories, keyboards for inputting data, displays for indicating results of calculation processing, interfaces for controlling input and output, and electric sources. Constituent equipment (such as personal computers) used in these systems can also communicate using the compressed data prepared. For example, communication through the Internet is possible.

In an example described herein, a still image is used as the dummy data, and the above-mentioned EZW (Embedded Zerotree Wavelet) is used as encoding algorithm. The EZW encoding is carried out according to the following procedure:

(1) An original image is subjected to the wavelet transform.

(2) The wavelet coefficients are quantized. Here, a significance map showing the positions of the wavelet coefficients having large absolute values and a refinement map indicating the binary expression of the wavelet coefficients are prepared.

(3) The significance map and the refinement map are subjected to entropy encoding.

There are two cases considered with respect to the embedding of information. One case is that an original image that is not compressed is given and confidential information is hidden (embedded) in the course of compression, and another is that a compressed image is given and confidential information is embedded therein.

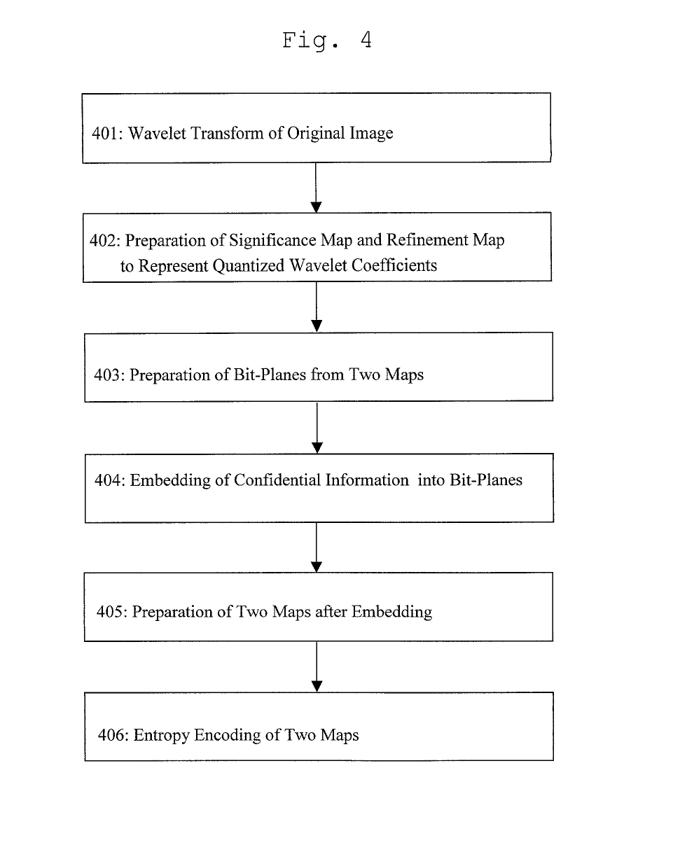

In the former case, as shown in FIG. 4, after (1) the wavelet transform of the original image 401, in (2) on quantization of the wavelet coefficients in the above-mentioned EZW encoding procedure, the following processes (a), (b), (c) and (d) are undergone.

That is to say, (a) the significance map and the refinement map are prepared to represent the quantized wavelet coefficients 402.

(b) Bit-planes are prepared from the significance map and the refinement map 403.

(c) Confidential information is embedded into the bit-planes 404 by steganography based on the bit-plane segmentation method (BPCS-steganography) described later.

(d) A significance map and a refinement map corresponding to the bit-planes into which the confidential information is embedded, are prepared 405.

Then, (3) entropy encoding of the significance map and the refinement map in the above-mentioned EZW encoding procedure is conducted 406.

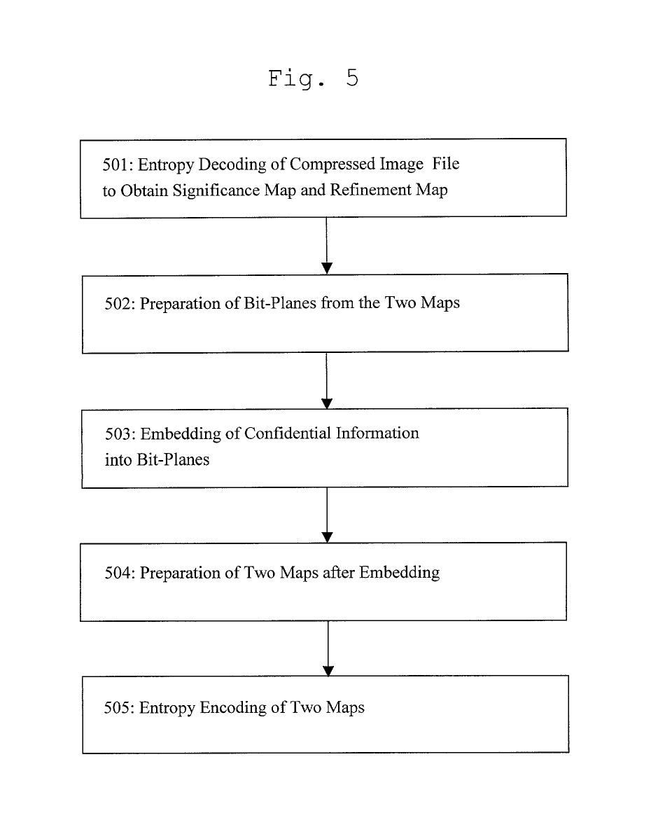

In the latter case, as shown in FIG. 5, processing for obtaining a significance map and a refinement map by entropy decoding 501 is required because an encoded file is already given by (1) to (3) of the EZW encoding procedure. The subsequent procedure is the same as with the former case. That is to say, the bit-plane structure is obtained from the significance map and the refinement map 502, and confidential information is embedded into the bit-planes by bit-plane decomposition steganography 503. A significance map and a refinement map are prepared from the bit-planes into which the confidential information is embedded 504, and they are subjected to entropy encoding 505.

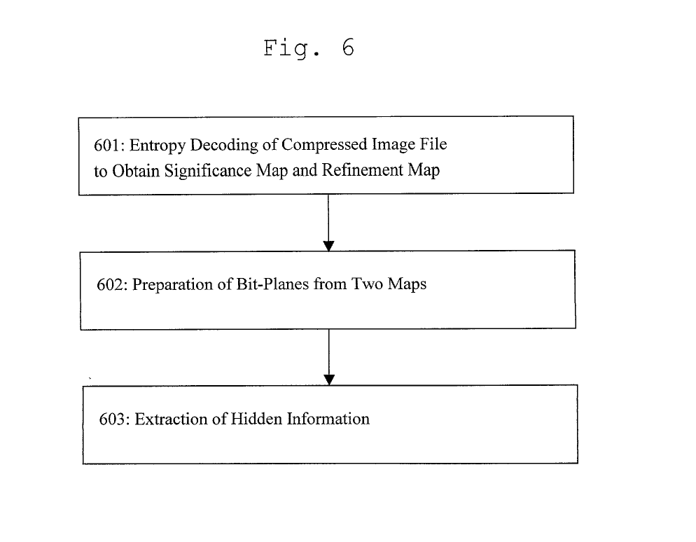

The confidential information is taken out of the compressed image file into which the confidential information is embedded, by the following procedure as shown in FIG. 6.

First, the compressed image file is subjected to entropy decoding to obtain a significance map and a refinement map 601. The bit-planes are then prepared from the significance map and the refinement map 602. The confidential information is extracted from each bit-plane 603 by the bit-plane complexity segmentation steganography (BPCS-steganography) shown below.

The term “BPCS-steganography” as used herein means a technique of replacing (embedding) portions with confidential data, paying attention to the complexity (randomness) of a binary pattern on each “bit-plane” obtained by slicing image data to each constituent bit. The embedding capacity by conventional steganography is from about 5% to about 10%, whereas the embedding capacity by BPCS-steganography reaches about 50% to about 70% in some cases. Thus, an epoch-making increase in capacity can be realized by BPCS-steganography.

Particularly, BPCS-steganography consists of the following four basic ideas. First, bit-plane decomposition is conducted on the pure binary code expression (PBC) of the image data or on the “canonical gray code expression (CGC)” converted from the pure binary code. Second, the bit-plane is divided into two kinds of regions (simple regions and complex regions) by a “measure of complexity” of the binary pattern, and the complex portions (random portions) are replaced (embedded) by the confidential data. Such replacement attracts no attention at all. Third, a “conjugation operation” is prepared to make it possible to embed any kind of confidential data. Fourth, a function of customizing the algorithm (encoding-decoding program) of the BPCS-steganography for each user is attached. Thus, the security of the embedded information with a “customizing key” different from a password has been established.

The most important feature of the BPCS-steganography technique is a high embedding capacity. However, it also has other advantages. For example, third persons are not aware of the embedded confidential information, and it is impossible to distinguish an image into which the confidential information is embedded from an image into which no confidential information is embedded. In addition, even if it is known that the confidential information is embedded, it cannot be extracted at all without the customizing key that dictates where and how the confidential information is taken out.

Embedding and extraction of information by the above-mentioned BPCS-steganography will be described below.

It is understood that a bit-plane of a natural image is scarcely visually influenced, even when noise-like regions are replaced by other noise-like data. The utilization thereof makes it possible to replace noise-like regions in a dummy image with confidential data. A criterion for judging whether the regions are noise-like or not varies depending on the dummy image, so that a threshold value suitable for each image is required to be determined.

When 2^{m}×2^{m} (usually, m=3) is taken as a local region size in a binary image, a region whose complexity value α satisfies α_{TH}≦α for a threshold value α_{TH} is a place into which confidential date is embedded. For embedding a confidential date file into a dummy image, the file is first segmented into 2^{m}×2^{m} bit file segments, which correspond to ₂^{m}×2^{m} pixels, and those respective file segments are successively embedded into ₂^{m}×2^{m} noise-like regions of the dummy image. However, all file segments do not necessarily have larger complexity values than α_{TH}. Then, such segments are complicated by the conjugation operation described below. It becomes possible to embed any confidential file into a dummy image by such operation. In this case, however, a “conjugation map” recording what regions of the image are conjugated must be stored, to enable complete restoration of the confidential file.

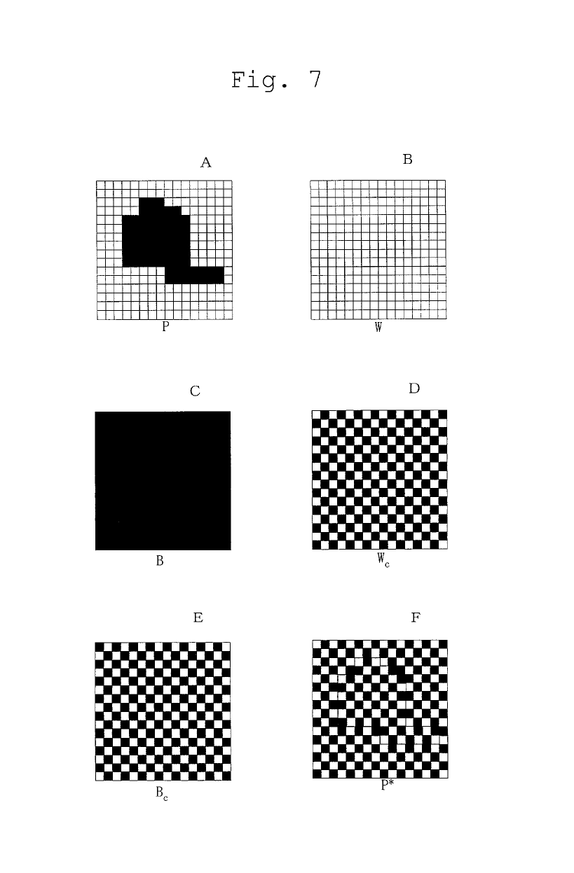

Hereinafter, the value of a white pixel is taken as 0, and the value of a black pixel is taken as 1. First, let P be an arbitrary binary image. As shown in FIG. 7A, the background in this P is white. W and B are each defined as a pattern in which all pixels are white and a pattern in which all pixels are black, as shown in FIGS. 7 B & 7C, respectively. Further, two checkerboard patterns are described as W_{c} and B_{c}, respectively, wherein W_{c} has a white pixel at the upper-left position, and B_{c} has a black pixel at the upper-left position, as shown in FIGS. 7D & 7E. P is interpreted as an image in which the foreground is B, and the background is W. Assuming the above, a “conjugated image” P* of P is defined as described below:

P*=P\mathring{+}W_{c}

wherein \mathring{+} means the exclusive OR operation for each pixel, as shown in FIG. 7F. An operation for obtaining the conjugate image shall be called a conjugation operation. P* can be considered to be an image in which the shape of the foreground is the same as that of P, the foreground region has a Bc pattern, and the background region has a Wc pattern. Such P and P* have a one-to-one correspondence. P and P* have the following properties:

(a)(P*)*=P

(b)P*≠P

(c)α(P*)=1−α(P)

wherein “α(P)” indicates the complexity value α of P.

Herein, the most important property is (c). This property shows that a simple image can be converted to a complex image, and vice versa, without losing shape information. The property (a) indicates that the original pattern is completely restored from its conjugated pattern.

The BPCS-steganography consists of the following five steps: Step 1:

A 2^{M}×2^{M}, N bit/pixel dummy image is converted to an N bit gray coded image. This is adopted based on a consideration on binary images obtained by bit-plane decomposition and their complexity discussed by Eiji Kawaguchi et al.

Step 2:

The gray coded image derived in step 1 is decomposed into a set of N binary images by bit-plane decomposition.

Step 3:

Each binary image is divided into 2^{m×}2^{m} block images. Here, the block images are expressed by Pi; i=1, 2, . . . ,4^{M-m}. The n-th bit-plane image, In, can be represented as follows:

In={P₁ⁿP₂ⁿ, Pⁿ₄^{n-m}}Similarly, the n-th “conjugation map”, Cn, can also be represented as follows:

Cn={Q₁ⁿ, Q₂ⁿ, . . . , Qⁿ₄^{M-m}}

wherein Q₁ⁿ, Q₂ⁿ, . . . , Qⁿ₄^{M-m} takes a value of “0” or “1”, wherein “1” means a region to which conjugation operation is applied, and “0” means a region to which it is not applied.

Embedding data, expressed by “E”, consists of three portions: a header, a main body and a pad. The header indicates the data size of the main body, and the main body is confidential data itself to be embedded, a confidential image for example. The pad is one for adjusting the data length to be embedded to 2^{m}×2^{m}. Let Ej (j=1, 2, . . . , J) be a series of blocks having a size of 2^{m}×2^{m} bits, derived by dividing E. Ej is considered as a 2^{m}×2^{m} binary image, and this image is expressed by makes (Ej).

Letting a threshold value be α_{TH}, an embedding algorithm can be represented as follows:

for (n=N,j=1; n≧1 && j<J; n--) {

for (i=1; i=4^{M-m}&&j <J; i++) {

if (α(Piⁿ)≧α_{TH}) {

if (α(makes(Ej))≧α_{TH})

Pᵢⁿ= makes(Ej)

else {

Pᵢⁿ= makes(Ej)*

Qᵢⁿ=”1”

}

j++;

}

}

}

Since a lower bit has little influence on an image, the embedding processing is successively carried out from the lowest bit-plane. When makes(Ej) is a simple region, that is to say, when the complexity of the region is lower than the threshold value, the conjugation operation is applied to makes(Ej). In this case, Qj is set to “1” of the conjugation map.

Step 4:

The N bit gray code is obtained from the N binary images into which the information is embedded.

Step 5:

Conversion of the gray code of step 4 to the pure binary code results in the formation of image data into which the confidential data is embedded. The confidential data is restored by performing this algorithm in reverse. For that purpose, the threshold value α_{TH} and the conjugation map are indispensable.

On the other hand, in the progressive compression, each wavelet coefficient W is expressed as W=T(a₀+a₁2⁻¹+a₂⁻²+. . . ),aᵢε{0,1}; wherein T is a constant satisfying (½)Wₘₐₓ=T<Wₘₐₓ, and Wₘₐₓ is a maximum value of the wavelet coefficients of the wavelet-transformed image.

The wavelet coefficient W is represented by the product of a binary decimal (a₀·a₁a₂ . . . )₂ and T, and a term of binary expression is present. This shows that the bit-plane structure can also be considered in the wavelet-transformed image.

In progressive compression, encoding is conducted in order from wavelet coefficients having large absolute values, and concurrently conducted in order from higher binary expressions (higher bit-planes). That is to say that encoding is conducted in order from more important information, such that decoding can be performed in order from more important information. Accordingly, even if decoding is discontinued on the way, a near optimal result of decoding is achieved under the information amount (decoded amount) obtained until that stage.

In the present invention, an original digital image is first prepared, and personal authentication information for embedding is prepared.

Then, the original digital image is subjected to the wavelet transform to obtain the wavelet-transformed image.

The wavelet coefficients thereof are represented as quantized ones by the significance map and the refinement map.

The bit-plane structure is obtained from these significance map and refinement maps.

Then, personal authentication information is embedded into the image having this bit-plane structure.

Finally, the significance map and the refinement map are subjected to entropy encoding, thereby being able to hide the information by steganography in a compressed image.

This compressed image data can be communicated through the Internet such that a third person is not aware of the presence of the hidden information. Therefore safe data communication can be realized. Further, the compressed image data can also be stored in the recording media. These recording media (such as CD-ROMs, IC cards and optical cards) are useful to store large-capacity compressed data.

The above-mentioned wavelet transform is further illustrated. When an original image is subjected to the wavelet transform, a wavelet-transformed image having the same size as the original image is obtained. The pixel values of the wavelet-transformed image are values of the wavelet coefficients.

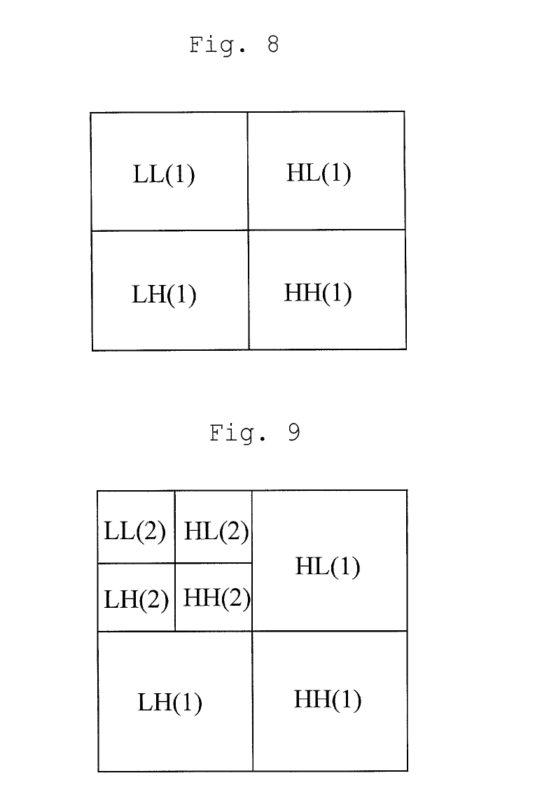

A one-level wavelet transform provides four decomposed images, as shown in FIG. 8. The respective decomposed images are an LL(1) image including low frequency components in both the horizontal and vertical directions of the image, an HH(1) image including high frequency components in both the horizontal and vertical directions, an HL(1) image including a high frequency component in the horizontal direction and a low frequency component in the vertical direction, and an LH(1) image including a low frequency component in the horizontal direction and a high frequency component in the vertical direction, wherein (1) indicates the resolution level of the image. The size of each of the four decomposed images is reduced to one half of the size of the original image, both vertically and horizontally, and then the resolution of each decomposed image is reduced to one half of the resolution of the original image.

In a two-level wavelet transform, the LL(1) image is further subjected to the wavelet transform. As shown in FIG. 9, the LL(1) image is decomposed into four images of LL(2), HL(2), LH(2) and HH(2) to give seven decomposed images in total. The size of each of the images to which (2) is attached is reduced to one half of that of the images to which (1) is attached. Further multi-level wavelet transform is performed by continuing a similar decomposition.

In the EZW and SPIHT methods, about a 5-level wavelet transform is used for an original image of size 512×512 pixels.

According to the present invention, a third person is not aware of the presence of the confidential information, so that the security thereof can be enhanced. Various kinds of media data are usually communicated in a compressed form and the present invention realizes steganography in such a natural form for the first time. In particular, for communication using video data, communication in a form other than a compressed form is impractical, and steganography using video data becomes possible by the present invention.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein. The method also works with black and white images and with images in other bit-mapped formats.

What is claimed is:

1. A method for hiding information in media data subjected to progressive compression, said method comprising the steps of:
compressing said media data;
preparing bit-planes with respect to the media data when performing said compressing step; and
embedding confidential information into said bit-plane structure using bit-plane decomposition steganography.

2. The method as claimed in claim 1 wherein said media data is chosen from a group consisting of acoustic data, still image data and video data.

3. The method as claimed in claim 1:
wherein said step of compressing said media data comprises the steps of:
subjecting the media data to a wavelet transform; and
preparing quantized wavelet coefficients;
wherein said preparing step comprises preparing bit-planes for said quantized wavelet coefficients;
wherein said embedding step comprises embedding confidential information into said bit-planes using bit-plane decomposition steganography to create embedded bit planes; and
wherein said step of compressing said media data further comprises the steps of:
preparing modified quantized wavelet coefficients based on said embedded bit-planes; and
performing entropy encoding of said modified quantized wavelet coefficients.

4. A method for confidentially communicating information, said method comprising the steps of:
hiding information in media data subjected to progressive compression, said hiding step comprising the steps of
compressing said media data;
preparing a bit-planes with respect to the media data when performing said compressing step; and
embedding confidential information into said bit-plane structure using bit-plane decomposition steganography to form embedded media; and
extracting said confidential information from the embedded media data.

5. The method as claimed in claim 4 wherein said extracting step comprises the steps of:
obtaining a bit-plane structure with respect to said media data; and
extracting said hidden information from the bit-plane structure.

6. The method as claimed in claim 5:
wherein said step of compressing said media data comprises the steps of:
subjecting the media data to a wavelet transform; and
preparing quantized wavelet coefficients;
wherein said preparing step comprises preparing bit-planes for said quantized wavelet coefficients;
wherein said embedding step comprises embedding confidential information into said bit-planes using bit-plane decomposition steganography to create embedded bit planes; and
wherein said step of compressing said media data further comprises the steps of:
preparing modified quantized wavelet coefficients based on said embedded bit-planes; and
performing entropy encoding of the modified quantized wavelet coefficients.

7. The method as claimed in claim 6 wherein said extracting step comprises:
subjecting media data to entropy decoding to obtain quantized wavelet coefficients;
obtaining a bit-plane structure from the quantized wavelet coefficients; and
extracting the hidden information from the bit-plane structure.

8. The method as claimed in claim 4, further comprising the step electronically sending said embedded media data prior to said extracting step.

9. The method as claimed in claim 8 wherein said step of electronically sending said embedded data comprises transmitting said data via an Internet protocol based network.

10. The method as claimed in claim 4 wherein said media data is chosen from a group consisting of acoustic data, still image data and video data.

11. A system for confidentially communicating information, said system comprising:
means for hiding information in media data subjected to progressive compression, said means comprising:
means for compressing said media data;
means for preparing bit-planes with respect to the media data when performing said compressing step; and
means for embedding confidential information into said bit-plane structure using bit-plane decomposition steganography to form embedded media; and
means for extracting said confidential information from the embedded media data.

12. The system as claimed in claim 11 wherein said means for extracting comprises:
means for obtaining a bit-plane structure with respect to said media data; and
means for extracting said hidden information from the bit-plane structure.

13. The system as claimed in claim 12:
wherein said means for compressing said media data comprises:
means for subjecting the media data to a wavelet transform; and
means for preparing quantized wavelet coefficients;
wherein said means for preparing comprises means for preparing bit-planes for said quantized wavelet coefficients;
wherein said means for embedding comprises means for embedding confidential information into said bit-planes using bit-plane decomposition steganography to create embedded bit planes; and
wherein said means for compressing said media data further comprises:
means for preparing modified quantized wavelet coefficients based on said embedded bit-planes; and
means for performing entropy encoding of the modified quantized wavelet coefficients.

14. The system claimed in claim 13 wherein means for extracting comprises:
means for subjecting media data to entropy decoding to obtain quantized wavelet coefficients;
means for obtaining a bit-plane structure from the quantized wavelet coefficients;
and means for extracting the hidden information from the bit-plane structure.

15. The system as claimed in claim 12, further comprising means for electronically sending said embedded media data prior to extracting said confidential information.

16. The method as claimed in claim 15 wherein said means for electronically sending said embedded data comprises means for transmitting said data via an Internet protocol based network.

17. The system as claimed in claim 11 wherein said media data is chosen from a group consisting of acoustic data, still image data and video data.
